(19) United States
(12) Patent Application Publication
(10) Pub. No.: US 2005/0216355 A1
(43) Pub. Date: Sep. 29, 2005

(54) Network auctioning apparatus, system and method of use thereof

(76) Inventor: Andrew Desormeau West, Loudonville, NY (US)

Correspondence Address: Schmeiser, Olsen & Watts LLP;Suite 201, 3 Lear Jet Lane, Latham, NY, 12110, US

(21) Appl. No.: 10/887,079

(22) Filed: Jul. 8, 2004

Related U.S. Application Data
(60) Provisional application No. 60/555,773, filed on Mar. 24, 2004.

(51) Int. Cl. G06F 17/60

(52) U.S. Cl. 705/26

(57) ABSTRACT

The invention provides an apparatus comprising a remote auction terminal operatively connected to a network auction via a network, wherein the remote auction terminal facilitates interactive screening during receipt of goods into the network auction. Moreover the invention provides a system and method of use for allowing conferencing between a seller and an agent, evaluating the seller's goods, conducting negotiations between the seller and the agent to structure an agreement for the agent to sell the seller's goods through a network auction to a buyer, shipping of seller's goods to an interim holding location, selling of seller's goods by the agent through a network auction to a buyer, shipping the goods from the interim holding location to the buyer, and completing a financial transaction between the seller and the buyer through the agent.

### BACKGROUND OF THE INVENTION

1. Field of Invention

The present invention generally relates to an apparatus, system and method for providing auctioning services. In particular, the present invention relates to an apparatus, system and method for providing network auctioning, wherein an agent sells or buys goods for sellers or buyers.

2. Related Art

Methods have been developed to facilitate auctioning systems, specifically network auctioning systems. Existing network auctioning systems attempt to allow sellers to provide goods to highest-bidding buyers. However, because of the variability and complexity of common network auctions, many buyers or sellers do not obtain a competent price for goods sold via a network auction or do not have the time to participate in these systems. Thus, a need exists for an apparatus, system and method of use that can allow buyers or sellers to enlist the services of an auction agent who is skilled in network auctioning techniques and who can more proficiently fetch an optimum price for goods bought or sold on behalf of buyers or sellers.

### SUMMARY OF THE INVENTION

The present invention provides an apparatus, system and method related to network auctioning which overcomes the aforementioned deficiencies and others by providing, inter alia, an apparatus, system and method of facilitating efficient exchange of goods, via an auction agent, through a network auction.

One aspect of the present invention is an apparatus comprising a remote auction terminal operatively connected to a network auction via a network, wherein the remote auction terminal facilitates interactive screening during receipt of goods into the network auction.

A second aspect of the present invention is an apparatus comprising a remote auction terminal operatively connected to a network auction and an agent via a network, wherein the remote auction terminal facilitates transactions with the agent and interactive screenings by the agent during receipt of goods into the network auction.

A third aspect of the present invention is a method of facilitating exchange of goods comprising the steps of conferencing between a seller and an agent, selling of seller's goods by the agent through a network auction to a buyer, shipping the goods to the buyer, and completing a financial transaction between the seller and the buyer through the agent.

A fourth aspect of the present invention is a method of facilitating exchange of goods through a network auction wherein the method comprises the steps of conferencing between a seller and an agent, evaluating seller's goods, wherein the agent determines an auctioning value of the goods, selling of seller's goods by the agent through a network auction to a buyer, shipping the goods to the buyer, and completing a financial transaction between the seller and the buyer through the agent.

A fifth aspect of the present invention is a method of facilitating exchange of goods through a network auction wherein the method comprises the steps of: first, conferencing between a seller and an agent, second, shipping of seller's goods to a holding location to facilitate interim storage of the goods, third, selling of seller's goods by the agent to a buyer, fourth, shipping the goods to the buyer, and fifth, completing a financial transaction between the seller and the buyer through the agent.

A sixth aspect of the present invention is a method of facilitating exchange of goods through a network auction wherein the method comprises the steps of conferencing between a seller and an agent, conducting negotiations between the seller and the agent to structure an agreement for the agent to sell the seller's goods through a network auction to a buyer, shipping the goods to the buyer, and completing a financial transaction between the seller and the buyer through the agent.

A seventh aspect of the present invention is a method of facilitating exchange of goods through a network auction wherein the method comprises the steps of conferencing between a seller and an agent, the conferencing facilitated by a remote auction terminal, selling of seller's goods by the agent to a buyer, shipping the goods to the buyer, and completing a financial transaction between the seller and the buyer through the agent.

An eighth aspect of the present invention is a method of facilitating exchange of goods through a network auction wherein the method comprises the steps of conferencing between a seller and an agent, the conferencing facilitated by a remote auction terminal located in a public shopping area or a retail premise of a shipping center, selling of seller's goods by the agent to a buyer, shipping the goods to the buyer, and completing a financial transaction between the seller and the buyer through the agent.

A ninth aspect of the present invention is a method of facilitating exchange of goods through a network auction wherein the method comprises the steps of conferencing between a seller and an agent, shipping of seller's goods to an interim holding location, wherein shipping is facilitated by a package carrier in conjunction with a shipping center, selling of seller's goods by the agent to a buyer, shipping the goods to the buyer, and completing a financial transaction between the seller and the buyer through the agent.

A tenth aspect of the present invention is a method of facilitating exchange of goods through a network auction wherein the method comprises the steps of conferencing between a seller and an agent, the conferencing facilitated by a remote auction terminal, evaluating seller's goods, wherein the agent determines an auctioning value of the goods, interactive screening of the goods, wherein the interactive screening is performed in real-time concurrent with receipt of goods into the network auction, and wherein the interactive screening is further performed prior to a sale of the goods received into the network auction, conducting negotiations between the seller and the agent to structure an agreement for the agent to sell the seller's goods through a network auction to a buyer, shipping of seller's goods to a holding location to facilitate interim storage of the goods, selling of seller's goods by the agent through a network auction to a buyer, shipping the goods by the agent from the interim holding location to the buyer, and completing a financial transaction between the seller and the buyer through the agent.

An eleventh aspect of the present invention is a method of facilitating exchange of goods comprising the steps of conferencing between a buyer and an agent, buying of goods by the agent through a network auction for the buyer, facilitating shipping of the goods by the seller to the buyer, and completing a financial transaction between the buyer and the seller through the agent.

A twelfth aspect of the present invention is a method of facilitating exchange of goods through a network auction wherein the method comprises the steps of conferencing between a buyer and an agent, the conferencing facilitated by a remote auction terminal, buying of goods by the agent through a network auction for the buyer, facilitating shipping of the goods by the seller to the buyer, and completing a financial transaction between the buyer and the seller through the agent.

A thirteenth aspect of the present invention is a method of facilitating exchange of goods through a network auction wherein the method comprises the steps of conferencing between a buyer and an agent, conducting negotiations between the buyer and the agent to structure an agreement to receive compensation for the agent to buy goods through a network auction for the buyer, buying of goods by the agent through a network auction for the buyer, facilitating shipping of the goods by the seller to the buyer, and completing a financial transaction between the buyer and the seller through the agent.

A fourteenth aspect of the present invention is a method of facilitating exchange of goods through a network auction wherein the method comprises the steps of conferencing between a buyer and an agent, the conferencing facilitated by a remote auction terminal, conducting negotiations between the buyer and the agent to structure an agreement to receive compensation for the agent to buy goods through a network auction for the buyer, buying of goods by the agent through a network auction for the buyer, facilitating shipping of the goods by the seller to the buyer, and completing a financial transaction between the buyer and the seller through the agent.

A fifteenth aspect of the present invention is a system for exchanging goods comprising a network, a network auction, and a remote auction terminal operatively connected to the network auction via the network, wherein the remote auction terminal facilitates interactive screening during receipt of goods into the network auction.

### BRIEF DESCRIPTION OF THE DRAWINGS

The features of the present invention will best be understood from a detailed description of the invention and an embodiment thereof selected for the purpose of illustration and shown in the accompanying drawings in which:

FIG. 1 depicts an embodiment of a remote auction terminal apparatus, in accordance with the present invention;

FIG. 2 depicts a system for an agent-assisted network auction transaction, in accordance with the present invention;

FIG. 3 depicts a system wherein an auction agent assists two sellers in selling goods via network auctions, in accordance with the present invention;

FIG. 4 depicts a system having a centralized holding location wherein an auction agent assists multiple sellers in selling goods via network auctions, in accordance with the present invention;

FIG. 5 depicts a system wherein buyers desiring to purchase goods from network auctions can utilize a remote auction terminal to enter into contracts with sellers through an auction agent for the agent to purchase goods on behalf of the buyer, in accordance with the present invention; and

FIG. 6 depicts a method of facilitating the exchange of goods via a network auction, in accordance with the present invention.

### DETAILED DESCRIPTION OF THE INVENTION

Although certain embodiments of the present invention will be shown and described in detail, it should be understood that various changes and modifications may be made without departing from the scope of any appended claims. The scope of the present invention will in no way be limited to the number of constituting components, the materials thereof, the shapes thereof, the relative arrangement thereof, etc. . . . , and are disclosed simply as an example of an embodiment. The features and advantages of the present invention are illustrated in detail in the accompanying drawings, wherein like reference numerals refer to like elements throughout the drawings. Although the drawings are intended to illustrate the present invention, the drawings are not necessarily drawn to scale.

The following are definitions:

Network as used herein is a communication system having a set of connections between potential buyers, sellers and agents wherein the connections are facilitated by arranged connection channels and junctions. The connection channels may comprise physical conduits such as phone lines, cable lines, radio-wave bands, television bands, satellite transmissions, fiber-optic filaments, structured light emissions such as infrared emissions or laser emissions, Wi-fi transmissions, Bluetooth™ wireless transmissions, and the like. The connection channels may also be virtual having only conceptual constructs necessary for uniting the communication system. The junctions may comprise physical components such as telephones, televisions, personal computers, main-frame computers, server computers, modems, satellites, cellular phones, short-range radios, long-range radios, PDA's, smartcards, and the like. The junctions may also use various protocols to facilitate communication between connection channels such as Lightweight Directory Access Protocol (LDAP), Transport Control Protocol/Internet Protocol (TCP/IP), Hypertext Transport Protocol (HTTP), Wireless Application Protocol (WAP), FCC radio band designations, File Transfer Protocol (FTP), Telnet, and the like. The junctions may also be virtual having only conceptual constructs necessary for uniting the communication system. The arranged set of connections and junctions together comprise a united communication system whereby information may be exchanged. Such communication systems include, but are not limited to the World Wide Web, the Internet, Wide Area Networks (WANs), Local Area Networks (LANs), Intranets pertaining to closed systems, Bluetooth™ Personal Area Networks (PANs), personal ad-hoc networks, designated-channel radio systems, postal networks, CCTV systems, electronic mail, chat systems, remote login systems, file sharing systems, file transfer systems, and the like.

Network auction as used herein is a physical or conceptual marketplace comprised within a network according to the present invention, the marketplace facilitating the exchange of goods. Goods are exchanged corresponding to bartering, bidding, negotiating, selling, and purchasing activities between buyers, sellers or buying and/or selling agents wherein the goods may be exchanged between a seller and highest bidder. Examples include, but are not limited to: online auctions such as Ebay.com, Ubid.com, proxibid.com, cheaporfreecars.com and Bidville.com; government auctions conducted by national, state or local governments and the like in countries throughout the world; real estate auctions; auctions appurtenant to distribution of an estate of a deceased; school and/or water district auctions; auctions where the buyers or sellers or agents are physically present at a location to bid on goods; and the like.

Internet as used herein is an interconnected system of networks that connects computers around the world to facilitate data transmission and exchange under various protocols thereby allowing for communication capabilities and the like.

Seller as used herein is any person, company, corporation, agent, software directive, artificial intelligence directive, entity, and the like that provides and/or seeks to provide goods exchanged in correlation with an economic transaction and the like.

Buyer as used herein is any person, company, corporation, agent, software directive, artificial intelligence directive, entity, and the like that purchases and/or seeks to purchase goods exchanged in correlation with an economic transaction and the like.

Agent as used herein is any person, company, corporation, agent, software directive, artificial intelligence directive, entity, and the like that facilitates the conducting of transactions between a seller and a buyer, provides, purchases and/or seeks to provide and/or purchase goods on behalf of a seller and/or buyer and operates as an entity though which sellers and/or buyers may exchange goods in accordance with the present invention. Moreover, an agent, as used herein, may evaluate goods and determine an auctioning value corresponding to the exchange of goods. Additionally, an agent may interactively screen goods being received into a network auction. Furthermore, an agent may conduct negotiations pertinent to an agreement to act on behalf of a seller and/or buyer in providing services and/or selling and/or purchasing goods. Further still, an agent according to the present invention, may ship goods on behalf of a seller and/or buyer. In addition, an agent may complete transactions or financial transactions with a seller and/or a buyer.

Goods as used herein are goods, services or any aspect of commerce that is capable of being sold or purchased. Examples include, but are not limited to, consumer goods such as consumer electronic devices, cameras, furniture, clothing, jewelry, sports equipment, kitchen appliances, mechanical tools, power tools, automobiles, water-craft, construction equipment, collectibles, movies, DVD's, video games, musical media, animals, and produce, real-estate, intellectual property, stocks and/or bonds as dictated by applicable regulations, oil and/or mineral rights as dictated by applicable regulations, pharmaceuticals as dictated by applicable regulations and the like

Facilitate as used herein is the capability to make possible the elements of the present invention that are being facilitated. Moreover, the capability to make possible may aid and/or assist performance of the elements of the present invention that are being facilitated.

Conferencing as used herein comprises communications between an agent and a seller and/or an agent and a buyer regarding an exchange of goods, wherein the communications may initiate, continue or resolve financial transactions, convey evaluated auction values of exchangeable goods, express negotiation dialogue, transmit documentation and the like.

Evaluating as used herein is an action wherein an agent assesses goods for the purpose of appraising the auctioning value of the goods. The auctioning value comprises a price estimate which the agent calculates will effect an optimal economic transaction in conjunction with the exchange of the goods via a network auction, or by some other means of exchange. The auctioning value may be communicated by an agent to a seller and/or buyer.

Interactive as used herein relates to the operation of exchanging goods wherein parties involved in the exchange may act or be capable of acting responsive to each other. The parties involved in the exchange may comprise any person, company, corporation, seller, buyer, agent, software directive, artificial intelligence directive, entity, and the like. Where a party comprises a software directive or artificial intelligence directive, such directives may comprise a program whose input and output are interleaved, like a conversation or dialogue interaction, allowing a user's input to depend on earlier output from the same run. The interaction with the user may be conducted through a text-based interface, a graphical user interface, an audio interface, a video interface and the like. Moreover, other kinds of interface, e.g. using speech recognition and/or speech synthesis, may also be used.

Screening as used herein is a process of examining goods to be exchanged via a network auction and vetting out goods that are not feasibly, economically, or efficiently auctionable, wherein auctionable is defined as capable of being auctioned. Examining the goods may comprise, viewing visible images of the goods, evaluating the goods, probing an owner about information pertaining to the goods, assessing authenticity of the goods origin, reviewing documentation pertaining to the goods and the like. Vetting out the goods may comprise a conclusion of the process of goods exchange wherein non-auctionable goods are not received into a network auction, the permissive assent to receive goods into a network auction, or the permissive assent to re-screen the goods in an iterative attempt to re-examine the goods to determine auctionability.

Conducting negotiations as used herein is the parley between an agent and a seller or an agent and a buyer, wherein the seller and/or buyer engages in communications with the agent to determine agreed upon economic terms whereby the agent will perform auctioning services for and in behalf of the seller and/or buyer.

Shipping as used herein is the transporting of goods. The transporting can be effectuated by common carriers such as UPS®, Federal Express®, DHL®, commercial airlines, commercial freight carriers, governmental postal carriers, and the like. Moreover, the transporting of goods may be initialized by a seller, buyer and/or agent, according to the present invention. Furthermore, the transporting of goods can commence from a seller, buyer, holding location, retail location, wholesale location, manufacturing location, shipping center and the like with conveyance of the goods to a buyer, holding location, retail location, wholesale location, shipping center and the like.

Completing a transaction or a financial transaction as used herein is the reimbursement for services performed on behalf of a seller and/or buyer. The reimbursement can be in the form of a cash payment, a credit card charge, a check, an ATM/Debit card charge, a cashier's check or combinations thereof. Further, the reimbursement is performed corresponding to agreed-upon terms of representation, wherein the terms may correspond to the barter, trade, scrip, or swap of goods as satisfaction for services rendered. As such, reimbursement may comprise a conveyance of goods for services rendered. Reimbursement may also include the retention of a portion of the sales proceeds for the transaction between the seller and the buyer. The reimbursement is completed when economic value commensurate with services rendered is received.

Operatively connected as used herein is the effective linking of elements of the present invention, wherein the linking allows the elements to perform in conjunction with one another.

Real-time as used herein is the actual time during which something occurs; that is, virtually current as opposed to delayed. Actual time relating to goods exchange activities according to the present invention, is the update information at a virtually current rate of data reception, wherein the data received may comprise information pertaining to networks, network auctions, sellers, buyers, agents, goods, conferencing, evaluating, interactive screening, completing transactions and the like or any combination thereof. Virtually current may describe an application which requires a program to respond to stimuli within some small upper limit of response time such as seconds, milliseconds microseconds and the like.

Receipt of goods as used herein is the admission of goods for exchange in a network auction. The admission may be commenced by a registration with the network auction to auction the goods. Moreover, admission may also comprise actual delivery of the goods to a physical location in conjunction with the network auction.

Freestanding device as used herein is a self-supporting apparatus having capability of holding firm a physical position for operative engagement of the device by a party. The apparatus may be detached from other physical supports or structures. The apparatus may also comprise physical connections to networks, wherein the connections and networks are in accordance with the present invention.

Business premise as used herein comprises a physical location wherein business activities may be conducted.

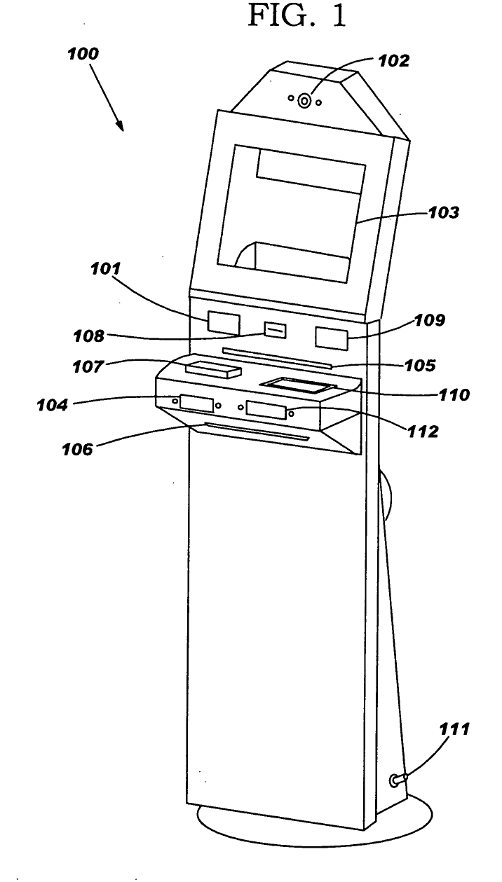

FIG. 1 depicts an embodiment of a remote auction terminal 100, according to the present invention. The remote auction terminal 100 may comprise a speaker 101, having capability of broadcasting communications pertaining to conferencing, evaluating, interactive screening, negotiating, or otherwise conveying audible information to one using the remote auction terminal 100. The speaker 101 may by of a type having a size sufficient so that it can efficiently be housed within a remote auction terminal 100. Moreover, the speaker 101 may also be of a type configured to broadcast at sufficient volume such that users may accurately hear the broadcast audible sounds even when the speaker 101 is housed within a remote auction terminal 100 located in an environment having surrounding noise. Such environments having related surrounding noise may include, but are not limited to, a business premise, the retail premise of a shipping center, a shopping mall, a personal residence, a business office, a street corner, an airport, a moving vehicle, an outdoor pavilion near outlet shopping malls, and the like.

As shown further in FIG. 1, the remote auction terminal 100 may also comprise a video camera 102, having capability of capturing visible images pertaining to conferencing, evaluating, interactive screening, negotiating, or otherwise capturing visual images pertaining to use of a remote auction terminal 100. The video camera 102 further includes capability of capturing moving images for transmission in both real time and/or time-delay transmissions. Moreover, the video camera 102, may include capability of capturing still images, the images having sufficient resolution such that those using a remote auction terminal 100, can easily and adequately distinguish the contents of images. Still further, the video camera 102 may include capability for one-way, two-way or multiple-user video conferencing.

One-way video conferencing may comprise video facilitated communication wherein a party on one end of a communication channel is video-captured on a video image in conjunction with using a remote auction terminal 100 to exchange goods. The video-capture may comprise a real-time video stream or it may comprise a time-delay video recording. Moreover, the video-capture, real-time stream or time-delay recording, may be transmitted in furtherance of communication, conferencing, evaluating and interactive screening facilitated by the remote auction terminal 100. Two-way video conferencing may comprise video facilitated communication wherein parties on both ends of a communication channel may be video-captured on video images in conjunction with using a remote auction terminal 100 to exchange goods. As such, the video-capture pertaining to two-way video conferencing may comprise concurrently broadcast real-time video streams of each party, or it may comprise time-delay video recordings of each party. Moreover, the video-capture pertaining to two-way video conferencing may be transmitted such that each party may view video images of the other party in either real-time or on a time-delay basis in furtherance of communication, conferencing, evaluating and interactive screening facilitated by the remote auction terminal 100. Multiple-user video conferencing may comprise video facilitated communication wherein multiple parties connected via multiple communication channels may be video-captured on video images in conjunction with the use of at least one remote auction terminal 100 to exchange goods. Video-capture pertaining to multiple-user video conferencing may comprise multiple concurrently broadcast real-time video streams of each conferencing party, or it may comprise time-delay video recordings of each conferencing party. Furthermore, the video-capture pertaining to multiple-user video conferencing may be transmitted such that each conferencing party may view video images of any other conferencing party in either real-time or on a time-delay basis in furtherance of communication, conferencing, evaluating and interactive screening facilitated by the remote auction terminal 100.

As shown further in FIG. 1, the remote auction terminal 100 may also comprise a display 103, having capability of depicting various visual media such as video streams, video recordings, graphical digital presentations, pixilated images, graphical user interface (GUI) images, and the like. The display 103 may comprise a liquid crystal display (LCD) monitor, a cathode ray tube (CRT) monitor, a mirror-reflected image display, a touch-screen user interface display, a holographic display, and the like. Where the display 103 facilitates a user interface, the interface may be conjunctive with software pertinent to the operation of various applications related to a remote auction terminal 100, may facilitate full or partial interaction between various parties communicating, conferencing, evaluating and interactive screening via the remote auction terminal 100, or may facilitate input and/or export of data communicated via the remote auction terminal 100.

As shown further in FIG. 1, the remote auction terminal 100 may also comprise a financial media port 104, having capability for receiving various financial media. The various financial media may comprise credit cards, debit cards, checks, smart cards, and standard currency. The standard currency may comprise coins or notes of legal tender of the United States of America or of the country in which the user operating the remote auction terminal 100 is located. The financial media port 104 may comprise multiple input sources such as a debit/credit card reader, a smart card reader, wherein the smart card may operate via magnetic proximity reading, wireless data transmission in the form of Wi-Fi, Bluetooth™ or infrared transmissions, a paper note reader, wherein the paper note reader has capability of determining the authenticity of a note being tendered, a coin machine, or combinations thereof. The Moreover, the financial medial port 104 may act in conjunction with the display 103 in gathering financial data, such as a debit/credit card number necessary for completion of a valid financial transaction.

As shown further in FIG. 1, the remote auction terminal 100 may also comprise a facsimile port 105. The facsimile port 105 may have capability for inputting data relating to product documentation, appraisals and the like. Moreover, the facsimile port 105 may be capable of scanning papered data relating to typed and/or hand-written documentation, forms, contracts, licenses, photographs, and the like.

As shown further still in FIG. 1, the remote auction terminal 100 may also comprise a printer output 106. The printer output 106 may have capability for printing black and white documents, forms, contracts, licenses, maps, bar codes, appraisals, and the like. Furthermore, the printer output 106 may also have capability of printing color images such as charts, graphs, banners, ads, maps photographs and the like. Moreover, the printer output 106, may have further capability of printing thermal and/or hot foil labels, decals, stickers, stamps, documents and the like.

As shown further in FIG. 1, the remote auction terminal 100 may comprise a scale 107, having capability of calculating the weight of various goods to be exchanged, The scale 107 may comprise a simple mechanical scale with balancing weights and/or springs accurately calibrated to depict the weight of goods placed on the scale 107. Moreover, the scale 107 may also comprise a digital scale having electrical components which aid in determining the weight of goods placed on the scale 107. Furthermore, the scale 107 may be fixed to the remote auction terminal 100, or may be removably coupled thereto so that a user might remove the scale 107 a distance from the remote auction terminal 100 and place goods that are larger than the remote auction terminal 100 on the scale 107 for measurement. It should also be appreciated that the scale 107 may be an external device plugged into the remote auction terminal 100 to facilitate transmission of measurement data.

As shown further in FIG. 1, the remote auction terminal 100 may also comprise a microphone 108, having capability of receiving audible communications pertaining to conferencing, evaluating, interactive screening, negotiating, or otherwise collecting audible information provided by one using the remote auction terminal 100. The microphone 108 may by of a type having a size sufficient so that it can efficiently be housed within a remote auction terminal 100. Moreover, the microphone 108 may also be of a type configured to receive audible communications at sufficient volume such that inputting users may easily provide audible sounds and communications without having to amplify the audible sounds and communications even when the microphone 108 is housed with in a remote auction terminal 100 located in an environment having surrounding noise. Such environments having related surrounding noise may include, but are not limited to, a business premise, the retail premise of a shipping center, a shopping mall, a personal residence, a business office, a street corner, an airport, a moving vehicle, an outdoor pavilion near outlet shopping malls, and the like. Furthermore, the audible communications received by the microphone 108 may be transmitted via a communication channel connected to the remote auction terminal 100, may be recorded and time-delay transmitted a communication channel, and/or may be amplified, sped up, slowed down and the like.

As shown further in FIG. 1, the remote auction terminal 100 may also comprise a universal video input 109, having capability of receiving pre-recorded video images. The universal video input 109 may comprise a an RCA plug, coaxial cable plug, serial port, IEEE 1394 (fire-wire) port, S-video port, digital video disk (DVD) drive, compact disk (CD) drive, memory-stick port and the like or any combination thereof. The pre-recorded video images may comprise analog moving video images, wherein the analog images may be converted to digital images, digital moving video images, still-frame digital images and the like. Additionally, the remote auction terminal 100, may have capability to process video images inputted via the universal video input 109 such that the processed images may be stored, compressed, or modified at the directive of those operating the remote auction terminal 100. Moreover, the remote auction terminal 100, may also have capability to process video images inputted via the universal video input 109 such that the processed images may be transmitted via communication channels in furtherance of communicating, conferencing, evaluating, interactive screening and/or negotiating.

As shown further in FIG. 1, the remote auction terminal 100 may also comprise a digital signature pad 110. The digital signature pad 110 may have capability of receiving physical signatures of parties using the remote auction terminal 100 to exchange goods, wherein the digital signature pad 110 may process physical signatures into digitalized versions while retaining signature authenticity. The digitalized versions of signatures may be such that the digital versions may be transmitted via digital communication channels and/or stored in digital media.

As shown further in FIG. 1, the remote auction terminal 100 may also comprise a power port 111. The power port 111 may comprise a permanently fixed electrical plug and cord, a removably coupled electrical plug and cord, a battery power supply port, a micro-electro-mechanical systems (MEMS) fuel cell, a hydrogen fuel cell, a solar power cell and the like or any combination thereof. The power port 111 may be equipped with transformers, reducers, capacitors, resistors and the like for the purpose of converting an electrical power source to a proper voltage and amperage for use pertaining to operation of a remote auction terminal 100.

As shown further still in FIG. 1, the remote auction terminal 100 may also comprise a communications port 112, having one and/or multiple inputs and capability of transmitting and/or receiving communications pertaining to a network. The network, according to the present invention, may comprise a communication system which may comprise a set of connections between parties using a remote auction terminal 100, wherein the connections are facilitated by arranged connection channels and junctions. The connection channels may comprise physical conduits such as phone lines, cable lines, radio-wave bands, television bands, satellite transmissions, fiber-optic filaments, structured light emissions such as infrared emissions or laser emissions, Wi-fi transmissions, Bluetooth™ wireless transmissions, and the like. As such, the communications port 112 may have multiple inputs compatible with connection channels which may comprise physical conduits such as phone lines, cable lines, radio-wave bands, television bands, satellite transmissions, fiber-optic filaments, structured light emissions such as infrared emissions or laser emissions, Wi-fi transmissions, Bluetooth™ wireless transmissions and the like or any combination thereof.

The junctions of a network comprising a communication system, according to the present invention, may comprise physical components such as telephones, televisions, personal computers, main-frame computers, server computers, modems, satellites, cellular phones, short-range radios, long-range radios, PDA's, smartcards, and the like. The junctions may also have keyboard inputs to facilitate communication. As such, the communications port 112 may have multiple inputs compatible with physical components such as telephones, televisions, personal computers, main-frame computers, server computers, modems, satellites, cellular phones, short-range radios, long-range radios, PDA's, smartcards, and the like. Moreover, the communications port 112 may include a keyboard input to facilitate communications. The junctions of a communication system according to the present invention may also use various protocols to facilitate communication between connection channels such as Lightweight Directory Access Protocol (LDAP), Transport Control Protocol/Internet Protocol (TCP/IP), Hypertext Transport Protocol (HTTP), Wireless Application Protocol (WAP), FCC radio band designations, File Transfer Protocol (FTP), Telnet, and the like. The remote auction terminal 100 may accordingly have capability for processing communications transmitted and/or received via one and/or multiple inputs of the the communications port 112, wherein the processing capabilities are compatible with communication protocols such as Lightweight Directory Access Protocol (LDAP), Transport Control Protocol/Internet Protocol (TCP/IP), Hypertext Transport Protocol (HTTP), Wireless Application Protocol (WAP), FCC radio band designations, File Transfer Protocol (FTP), Telnet, and the like.

A network comprising a communications system, according to the present invention, may comprise, but is not limited to the comprisal of, the World Wide Web, the Internet, Wide Area Networks (WANs), Local Area Networks (LANs), Intranets pertaining to closed systems, Bluetooth™ Personal Area Networks (PANs), personal ad-hoc networks, designated-channel radio systems, digital postal networks, CCTV systems, electronic mail, chat systems, remote login systems, file sharing systems, file transfer systems and the like. As such, the communications port 112 may be compatible with communication systems such as World Wide Web, the Internet, Wide Area Networks (WANs), Local Area Networks (LANs), Intranets pertaining to closed systems, Bluetooth™ Personal Area Networks (PANs), personal ad-hoc networks, designated-channel radio systems, digital postal networks, CCTV systems, electronic mail, chat systems, remote login systems, file sharing systems, file transfer systems and the like or any combination thereof. Moreover, the remote auction terminal 100 may have capability to process communication transmissions and/or receptions according to communication systems of the present invention.

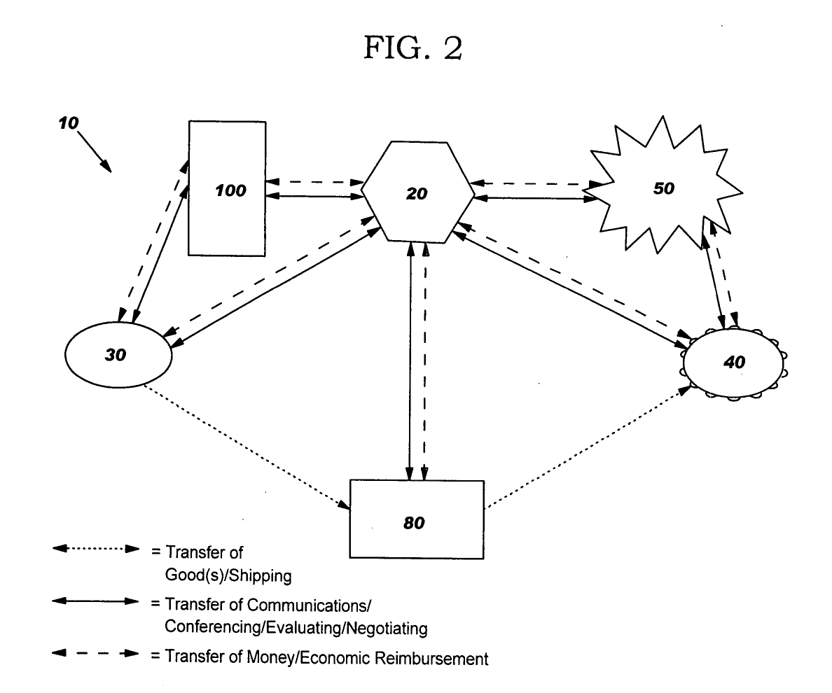

FIG. 2 depicts an embodiment of the present invention, a system 10 for providing network auctioning. The system 10 is configured such that an auction agent 20 may facilitate an exchange of goods between a seller 30 and a buyer 40. Moreover, the system 10 is configured such that a remote auction terminal 100 is operatively connected to a network auction 50 and/or the auction agent 20 via a network.

As shown further in FIG. 2, the system 10 facilitates a method for a remote seller 30 interaction with an auction agent 20 comprising conferencing between the seller 30 and the agent 20. The conferencing may be facilitated by a remote auction terminal 100, through which the seller 30 may initiate a communications contact with the auction agent 20. The initiation of the communications contact may be accomplished by a user interface of the seller 30 directing the remote auction terminal 100 to transfer communications to the auction agent 20. The auction agent 20, following the reception of the initiated communications contact, may proceed to conference with the seller 30. The conferencing by the auction agent 20 with the seller 30 may comprise communications between the auction agent 20 and the seller 30 regarding a potential exchange of goods. The communications regarding the potential exchange of goods may comprise the seller 30 presenting goods to be exchanged to the auction agent 30. The presentation of the goods may be accomplished by the seller 30 inputting data into the remote auction terminal 100. The data may comprise a video image or images of the goods, a typed description of the goods, documentation certifying age, make and authenticity of the goods, audible noises, if any, made by the goods, the weight of the goods, and seller's 30 personal audible description of the goods. The presented data may be transferred from the remote auction terminal 100 to the auction agent 20 for evaluation and interactive screening. The transfer of data may be facilitated by a network comprising a communications system having communications channels in accordance with the present invention.

As shown further in FIG. 2, the system 10 facilitates a method for evaluating goods presented by the seller 30 to the auction agent 20. Evaluating may comprise the agent's 20 assessment of the goods for the purpose of appraising the auctioning value of the goods. The auctioning value of the goods may comprise a price estimate which the auction agent 20 calculates will effect an optimal economic transaction in conjunction with the exchange of the goods via a network auction 50, or by some other means of exchange. The auction agent's 20 evaluation of the goods and corresponding auctioning value may be transferred by the agent 20 to the seller 30 via the remote auction terminal 100.

As shown further in FIG. 2, the system 10 facilitates a method for interactive screening goods during receipt into the network auction 50. The interactive screening may comprise an exchange wherein an auction agent 20 and a seller 30 may act or be capable of acting responsive to each other. The interaction between the seller 30 and the auction agent 20 may be conducted through a text-based interface, a graphical user interface, an audio interface, a video interface and the like. Where the auction agent 20 comprises a software directive or artificial intelligence directive, such directives may comprise programs whose input and output are interleaved, like a conversation or dialogue interaction, allowing the seller's 30 input to depend on earlier output from the same run executed by the directive auction agent 20. Accordingly, other kinds of interface, e.g. using speech recognition and/or speech synthesis, may also be used.

In further accordance with the embodiment of a method of interactive screening as shown in FIG. 2, the seller's 30 goods to be exchanged via a network auction are screened, wherein the goods are examined and vetted out. The examining of goods may be performed by an auction agent 20. Goods that are not feasibly, economically, or efficiently auctionable are vetted out. Examining the goods may comprise, viewing visible images of the goods, evaluating the goods, probing the seller 30 about information pertaining to the goods, assessing authenticity of the goods' origin, reviewing documentation pertaining to the goods and the like. Vetting out the goods may comprise a conclusion of the process of goods exchange wherein non-auctionable goods are not received into the network auction 50. The permissive assent to receive seller's 30 goods into a network auction may be provided by an auction agent 20, or the auction agent 20 may provide permissive assent to re-screen the goods in an iterative attempt to re-examine the goods to determine auctionability.

As shown further in FIG. 2, the system 10 facilitates a method for forming a selling agreement between the seller 30 and the auction agent 20. The method for forming a selling agreement may comprise conducting negotiations between the seller 30 and the auction agent 20. The negotiations may comprise the parley between the seller 30 and the auction agent 20, wherein the seller 30 engages in communications with the agent 20 to determine agreed upon economic terms whereby the agent 20 may perform auctioning services for and on behalf of the seller 30. The negotiation communications may comprise audible exchanges of verbal communication, visual exchanges of communication, such as gestures, movement of lips, body actions, sign language and the like, written and/or typed communications, forms, licenses, waivers, contracts, disclosures and the like or any combination thereof. Moreover, the negotiation communications may be transferred between the seller 30 and the auction agent 20 via the remote auction terminal 100 and corresponding network according to the present invention. The negotiations pertinent to the method for forming a selling agreement may also comprise an agreement structure whereby the auction agent 20 agrees to sell the seller's 30 goods through a network auction 50 to a buyer 40.

As shown further in FIG. 2, the system 10 also facilitates a method for transporting the goods of a seller 30. The transportation of the goods may comprise shipping of the seller's 30 goods to a holding location 80 to facilitate interim storage of the goods. The holding location 80 may be operative such that the auction agent 20 can conveniently store goods of various types according to the present invention. Moreover, the holding location 80 may be centralized such that goods received can be stored at a hub location after shipment from the seller 30 and prior to shipment to the buyer 40. Centralized storage of the goods may assist the auction agents 20 in selling and then shipping the goods to the buyer 40.

The shipping of the seller's 30 goods may be facilitated by a method whereby the seller 30 may drop off the goods at a remote location such as a business premise, wherein the business premise may comprise the retail premise of a shipping center that facilitates package shipments. The remote location may house the remote auction terminal 100. Thus the seller 30 may engage in communicating, conferencing, evaluating, interactive screening and/or negotiating with the auction agent 20 all while the seller 30 is physically located in the retail premise of the shipping center wherein the remote auction terminal 100 is housed. Because the remote auction terminal 100 may be housed within the retail premise of a shipping center that facilitates package shipment, the seller 30 may also ship the goods to the agent 20 by utilizing the packaging and shipping services provided by the shipping center. Furthermore, the shipping center may act in conjunction with a package carrier to transport goods. Thus, the seller's 30 goods may be transported by the package carrier to the interim holding location 80. The package carrier may then act in conjunction with the auction agent 20 to provide transportation and shipment of the goods to a buyer 40 once the goods have been sold.

As shown further in FIG. 2, the system 10 facilitates a method for selling a seller's 30 goods. The sale of the goods may comprise selling of the goods by the auction agent 20 through a network auction 50 to a buyer 40. The network auction 50 may comprise a physical or conceptual marketplace comprised within a network according to the present invention, the marketplace facilitating the exchange of goods. Goods may be exchanged corresponding to bartering, bidding, negotiating, selling, and purchasing activities between the buyer 40, the seller 30 or the buying and/or selling auction agent 20 wherein the goods may be exchanged between the seller 30 and a highest bidding buyer 40. Examples of a network auction 50 include, but are not limited to: online auctions such as Ebay.com, Ubid.com, proxibid.com, cheaporfreecars.com and Bidville.com; government auctions conducted by national, state or local governments and the like in countries throughout the world; real estate auctions; auctions appurtenant to distribution of an estate of a deceased; school and/or water district auctions; auctions where the buyer 40 or seller 30 or auction agent 20 may be physically present at a location to bid on goods; and the like.

As shown further still in FIG. 2, the system 10 facilitates a method for completing a financial transaction between the seller 30 and the buyer 40 through the auction agent 20. Completion of the financial transaction may comprise the reimbursement for services performed by the auction agent 20 on behalf of the seller 30. The economic reimbursement may be in the form of a cash payment, a credit card charge, a check, an ATM/Debit card charge, a cashier's check or combinations thereof. Further, the reimbursement may be performed corresponding to agreed-upon terms of representation between the seller 30 and the auction agent 20, wherein the terms may correspond to the barter, trade, scrip, or swap of goods as satisfaction for services rendered. As such, reimbursement may also be in the form of seller's 30 goods conveyed to the auction agent 20 for services rendered. Reimbursement may also include the retention by the agent 20 of a portion of the sales proceeds for the transaction between the seller 30 and the buyer 40. The reimbursement is completed when economic value commensurate with services rendered on behalf of the seller 30 is received by the auction agent 20.

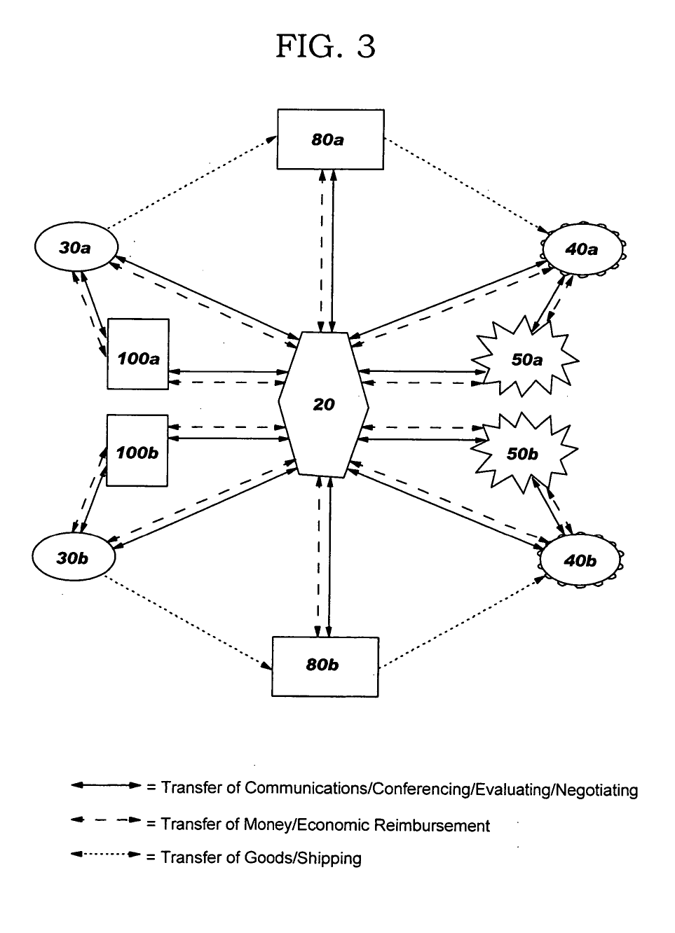

FIG. 3 depicts another embodiment of a system 10 of the present invention for providing network auctioning. This embodiment of the system 10 is configured, in ways similarly to the embodiment depicted in FIG. 2, yet differs in that an auction agent 20 may facilitate an exchange of goods between a plurality of sellers 30 (e.g., 30a, 30b, etc.) and a plurality of buyers 40 (e.g., 40a, 40b, etc.). Moreover, the system 10 is configured such that a plurality of remote auction terminals 100 (e.g., 100a, 100b, etc.) are operatively connected to a plurality of network auctions 50 (e.g., 50a, 50b, etc.) and the auction agent 20 via a network 10. Additionally, the network 10 may include a plurality of holding locations 80 (80a, 80b, etc.).

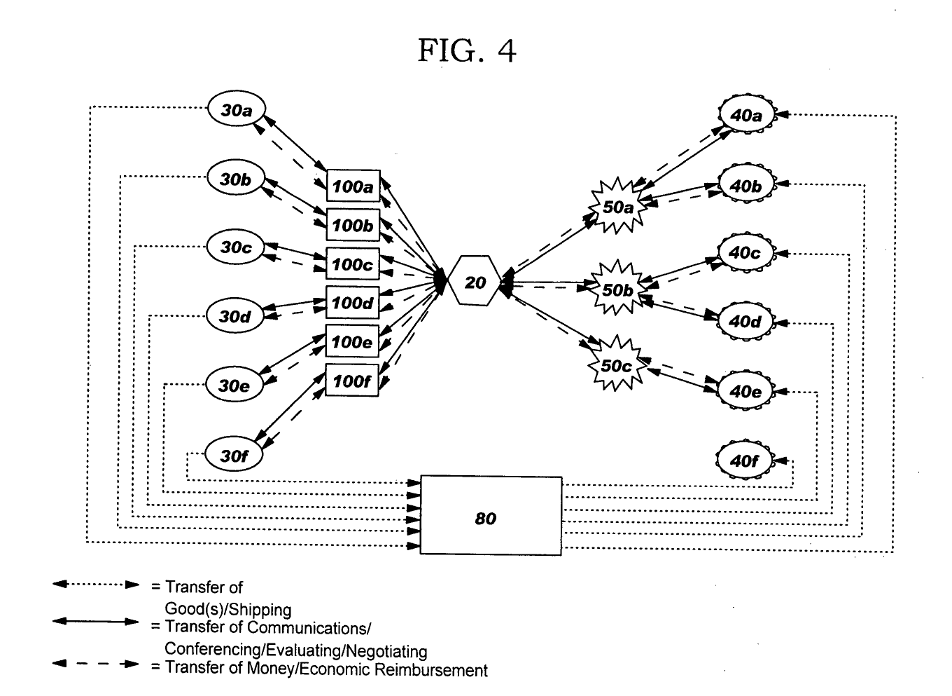

FIG. 4 depicts another embodiment of a system 10 of the present invention for providing network auctioning. This embodiment of the system 10 is configured, in ways similar to the embodiments depicted in FIG. 2 and FIG. 3, yet differs in that an auction agent 20 may facilitate an exchange of goods between a plurality of sellers 30 (e.g., 30a, 30b, 30c, 30d, 30e, 30f, etc.) and a plurality of buyers 40 (e.g., 40a, 40b, 40c, 40d, 40e, 40f, etc.). Moreover, the system 10 is configured such that a plurality of remote auction terminals 100 (e.g., 100a, 100b, 100c, 100e, 100f, etc.) are operatively connected to a plurality of network auctions 50 (e.g., 50a, 50b, 50c, etc.) and the auction agent 20.

In this embodiment, a first plurality of buyers 40 may operatively connected to a first auction 50, while a second plurality of buyers 40 may be operatively connected to second network auction 50. For example, as depicted, a first group of buyers 40a, 40b is connected to a first network auction 50a. Similarly, a second group of buyers 40c, 40d is connected to a second network auction 50b. A third group of buyers 40e, 40f is connected to a third network auction 50c.

In this manner, it allows the plurality of sellers 30 to select the particular germane, or desired, network auction 50a, 50b, 50c. For example, a first network auction 50a might have an attribute that the first seller 30a desires. The attribute may be certain characteristics of the buyers 40, the types of goods typically sold, the speed at which goods are sold, the location of the auction 50, the type of auction, and the like.

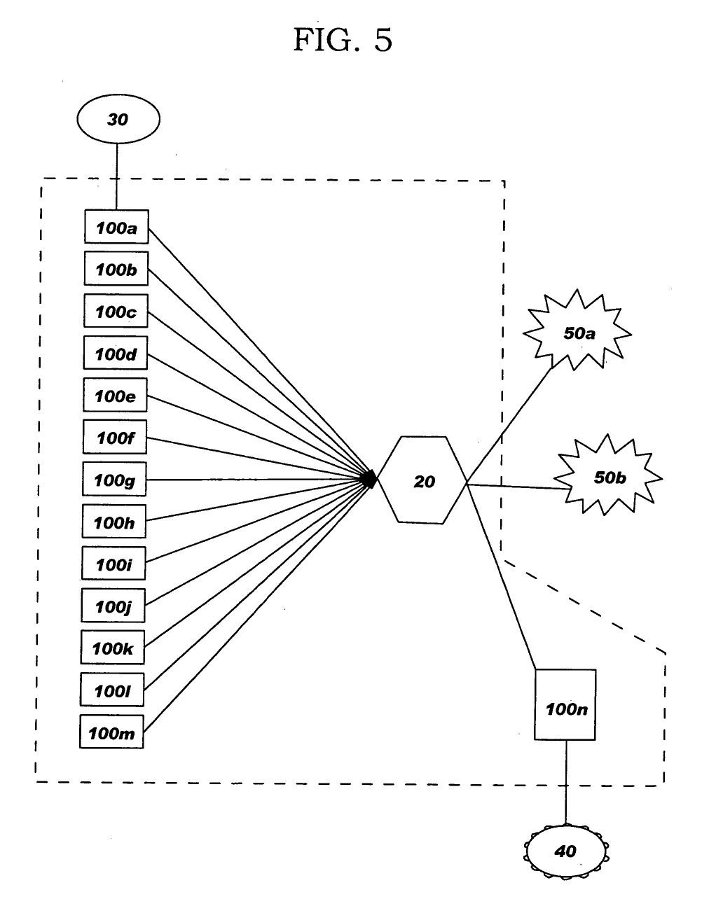

FIG. 5 depicts still another embodiment of a system 10 of the present invention for providing network auctioning. This embodiment of the system 10 is configured, in ways similar to the aforementioned embodiments (See e.g., FIGS. 2-4), yet differs in that an auction agent 20 may facilitate an exchange of goods between at least one seller 30 and at least one buyer 40. Moreover, the system 10 is configured such that a plurality of remote auction terminals 100 (e.g., 100a, 100b, 100c, 100e, 100f, etc.) are operatively connected to a plurality of network auctions 50 (e.g., 50a, 50b, etc.) and the auction agent 20.

In this embodiment, the at least one buyer 40 may operatively connected to the plurality of auctions 50a, 50b via a remote auction terminal 100n, as well. In this manner, the at least one buyer 40 may access the network 10 similarly to the plurality of sellers 30.

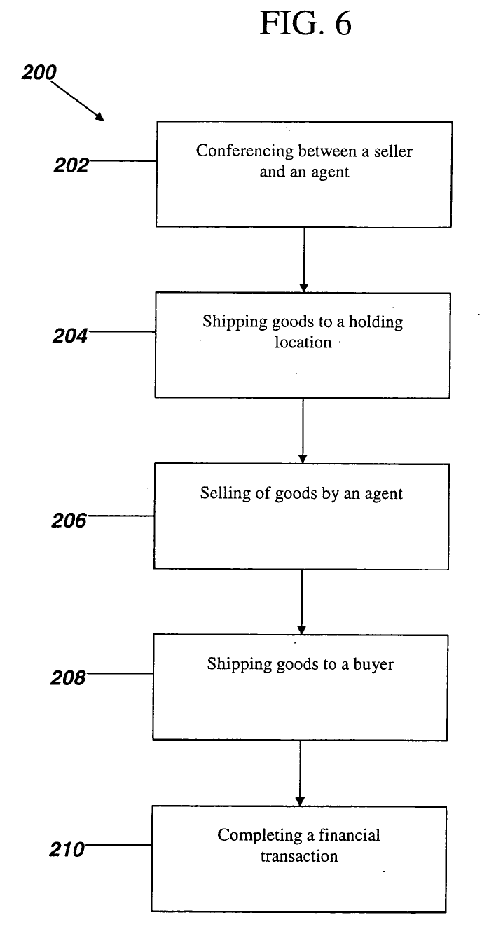

FIG. 6 depicts an embodiment of a method, denoted by 200, in accordance with the present invention. The method of the invention includes the conferencing between the seller and agent 202; shipping the goods to a holding location 204; selling of the goods by an agent 206; shipping goods to a buyer 208; and, completing a financial transaction 210.

Various modifications and variations of the described apparatus and methods of the invention will be apparent to those skilled in the art without departing from the scope and spirit of the invention. Although the invention has been described in connection with specific embodiments, outlined above, it should be understood that the invention should not be unduly limited to such specific embodiments. Various changes may be made without departing from the spirit and scope of the invention as defined in the following claims.

1. An apparatus comprising:
a remote auction terminal operatively connected to a network auction via a network;
wherein the remote auction terminal facilitates interactive screening during receipt of goods into the network auction.

2. An apparatus according to claim 1, wherein the interactive screening is performed in real-time concurrent with receipt of the goods into the network auction.

3. An apparatus according to claim 1, wherein the interactive screening is performed prior to a sale of the goods received into the network auction.

4. An apparatus according to claim 1, wherein the remote auction terminal is a freestanding device or kiosk.

5. An apparatus according to claim 4, wherein the freestanding device or kiosk includes capabilities selected from the group consisting of:
a. capability for live real-time or time delay conferencing;
b. capability for one-way, two-way or multiple-user video conferencing;
c. capability for input of electronic and written signatures;
d. capability for keyboard input of communications data;
e. capability for input and export of facsimile transmissions;
f. capability for input of digital and film photographs;
g. capability for printing labels, maps, and instructions;
h. capability for printing legal documents; and,
i. capability for receiving various financial media.

6. An apparatus according to claim 5, wherein the legal documents comprise contracts, license agreements and signature verification certificates.

7. An apparatus according to claim 5, wherein the various financial media comprise credit cards, debit cards, checks, smart cards, and standard currency.

8. An apparatus according to claim 1, wherein the remote auction terminal is operatively connected to an agent via a network.

9. An apparatus according to claim 8, wherein the remote auction terminal facilitates capability for evaluating goods, wherein the evaluating comprises the agent's determining of an auctioning value of the goods.

10. An apparatus according to claim 8, wherein the remote auction terminal facilitates capability for conducting negotiations between a seller and the agent to structure an agreement for the agent to sell the seller's goods through a network auction to a buyer.

11. An apparatus according to claim 8, wherein the remote auction terminal facilitates capability for conducting negotiations between a buyer and the agent to structure an agreement for the agent to purchase goods through a network auction for the buyer.

12. An apparatus according to claim 4, wherein the freestanding device or kiosk is located in business premise, a public shopping area or a retail premise of a shipping center.

13. An apparatus according to claim 12, wherein the freestanding device or kiosk further comprises the capability of facilitating shipping of goods.

14. An apparatus according to claim 13, wherein shipping is facilitated by a package carrier in conjunction with the shipping center.

15. An apparatus comprising:
a remote auction terminal operatively connected to a network auction and an agent via a network;
wherein the remote auction terminal facilitates transactions with the agent and interactive screenings by the agent during receipt of goods into the network auction.

16. An apparatus according to claim 15, wherein the interactive screening is performed in real-time concurrent with receipt of the goods into the network auction.

17. An apparatus according to claim 15, wherein the interactive screening is performed prior to a sale of the goods received into the network auction.

18. An apparatus according to claim 15, wherein the remote auction terminal is a freestanding device or kiosk.

19. An apparatus according to claim 18, wherein the freestanding device or kiosk includes capabilities selected from the group consisting of:
a. capability for live real-time or time delay conferencing;
b. capability for one-way, two-way or multiple-user video conferencing;
c. capability for input of electronic and written signatures;
d. capability for keyboard input of communications data;
e. capability for input and export of facsimile transmissions;
f. capability for input of digital and film photographs;
g. capability for printing labels, maps, and instructions;
h. capability for printing legal documents; and,
i. capability for receiving various financial media.

20. An apparatus according to claim 19, wherein the legal documents comprise contracts, license agreements and signature verification certificates.

21. An apparatus according to claim 19, wherein the various financial media comprise credit cards, debit cards, checks, smart cards, and standard currency.

22. An apparatus according to claim 15, wherein the remote auction terminal facilitates capability for evaluating goods, wherein the evaluating comprises the agent's determining of an auctioning value of the goods.

23. An apparatus according to claim 15, wherein the remote auction terminal facilitates capability for conducting negotiations between a seller and the agent to structure an agreement for the agent to sell the seller's goods through a network auction to a buyer.

24. An apparatus according to claim 15, wherein the remote auction terminal facilitates capability for conducting negotiations between a buyer and the agent to structure an agreement for the agent to purchase goods through a network auction for the buyer.

25. An apparatus according to claim 18, wherein the freestanding device or kiosk is located in business premise, a public shopping area or a retail premise of a shipping center.

26. An apparatus according to claim 25, wherein the freestanding device or kiosk further comprises the capability of facilitating shipping of goods.

27. An apparatus according to claim 26, wherein shipping is facilitated by a package carrier in conjunction with the shipping center.

28. A method of facilitating exchange of goods comprising the steps of:
conferencing between a seller and an agent;
selling of seller's goods by the agent through a network auction to a buyer;
shipping the goods to the buyer; and,
completing a financial transaction between the seller and the buyer through the agent.

29. A method according to claim 28, wherein the step of conferencing is facilitated by a remote auction terminal operatively connected to a network auction and the agent via a network.

30. A method according to claim 29, wherein the operative connection of the remote auction terminal is by land based phone systems, cable systems or wireless systems.

31. A method according to claim 29, wherein the remote auction terminal is a freestanding device or kiosk.

32. A method according to claim 31, wherein the freestanding device or kiosk includes capabilities selected from the group consisting of:
a. capability for live real-time or time delay conferencing;
b. capability for one-way, two-way or multiple-user video conferencing;
c. capability for input of electronic and written signatures;
d. capability for keyboard input of communications data;
e. capability for input and export of facsimile transmissions;
f. capability for input of digital and film photographs;
g. capability for printing labels, maps, and instructions;
h. capability for printing legal documents; and,
i. capability for receiving various financial media.

33. A method according to claim 32, wherein the legal documents comprise contracts, license agreements and signature verification certificates.

34. A method according to claim 32, wherein the various financial media comprise credit cards, debit cards, checks, smart cards, and standard currency.

35. A method according to claim 28, the method further comprising the step of evaluating seller's goods, wherein the agent determines an auctioning value of the goods.

36. A method according to claim 28, the method further comprising the step of interactive screening of the goods.

37. A method according to claim 36, wherein the interactive screening is performed in real-time concurrent with receipt of goods into the network auction.

38. A method according to claim 36, wherein the interactive screening is further performed prior to a sale of the goods received into the network auction.

39. A method according to claim 28, the method further comprising the step of conducting negotiations between the seller and the agent to structure an agreement for the agent to sell the seller's goods through a network auction to a buyer.

40. A method according to claim 31, wherein the freestanding device or kiosk is located in a public shopping area or a retail premise of a shipping center.

41. A method according to claim 28, the method further comprising the step of shipping of seller's goods to a holding location to facilitate interim storage of the goods.

42. A method according to claim 41, wherein the seller's goods are shipped by the agent from the interim holding location to the buyer.

43. A method according to claim 42, wherein shipping is facilitated by a package carrier in conjunction with the shipping center.

44. A method of facilitating exchange of goods through a network auction wherein the method comprises the steps of:
conferencing between a seller and an agent;
evaluating seller's goods, wherein the agent determines an auctioning value of the goods;
selling of seller's goods by the agent through a network auction to a buyer, shipping the goods to the buyer; and,
completing a financial transaction between the seller and the buyer through the agent.

45. A method according to claim 44, wherein the step of conferencing is facilitated by a remote auction terminal operatively connected to a network auction and the agent via a network.

46. A method according to claim 45, wherein the operative connection of the remote auction terminal is by land based phone systems, cable systems or wireless systems.

47. A method according to claim 45, wherein the remote auction terminal is a freestanding device or kiosk.

48. A method according to claim 47, wherein the freestanding device or kiosk includes capabilities selected from the group consisting of:
a. capability for live real-time or time delay conferencing;
b. capability for one-way, two-way or multiple-user video conferencing;
c. capability for input of electronic and written signatures;
d. capability for keyboard input of communications data;
e. capability for input and export of facsimile transmissions;
f. capability for input of digital and film photographs;
g. capability for printing labels, maps, and instructions;
h. capability for printing legal documents; and,
i. capability for receiving various financial media.

49. A method according to claim 48, wherein the legal documents comprise contracts, license agreements and signature verification certificates.

50. A method according to claim 48, wherein the various financial media comprise credit cards, debit cards, checks, smart cards, and standard currency.

51. A method according to claim 44, the method further comprising the step of interactive screening of the goods.

52. A method according to claim 51, wherein the interactive screening is performed in real-time concurrent with receipt of goods into the network auction.

53. A method according to claim 51, wherein the interactive screening is further performed prior to a sale of the goods received into the network auction.

54. A method according to claim 44, the method further comprising the step of conducting negotiations between the seller and the agent to structure an agreement for the agent to sell the seller's goods through a network auction to a buyer.

55. A method according to claim 47, wherein the freestanding device or kiosk is located in a public shopping area or a retail premise of a shipping center.

56. A method according to claim 44, the method further comprising the step of shipping of seller's goods to a holding location to facilitate interim storage of the goods.

57. A method according to claim 56, wherein the seller's goods are shipped by the agent from the interim holding location to the buyer.

58. A method according to claim 57, wherein shipping is facilitated by a package carrier in conjunction with the shipping center.

59. A method of facilitating exchange of goods through a network auction wherein the method comprises the steps of:
first, conferencing between a seller and an agent;
second, shipping of seller's goods to a holding location to facilitate interim storage of the goods;
third, selling of seller's goods by the agent to a buyer;
fourth, shipping the goods to the buyer; and,
fifth, completing a financial transaction between the seller and the buyer through the agent.

60. A method according to claim 59, wherein the step of conferencing is facilitated by a remote auction terminal operatively connected to a network auction and the agent via a network.

61. A method according to claim 60, wherein the operative connection of the remote auction terminal is by land based phone systems, cable systems or wireless systems.

62. A method according to claim 60, wherein the remote auction terminal is a freestanding device or kiosk.

63. A method according to claim 62, wherein the freestanding device or kiosk includes capabilities selected from the group consisting of:
a. capability for live real-time or time delay conferencing;
b. capability for one-way, two-way or multiple-user video conferencing;
c. capability for input of electronic and written signatures;
d. capability for keyboard input of communications data;
e. capability for input and export of facsimile transmissions;
f. capability for input of digital and film photographs;
g. capability for printing labels, maps, and instructions;
h. capability for printing legal documents; and,
i. capability for receiving various financial media.

64. A method according to claim 63, wherein the legal documents comprise contracts, license agreements and signature verification certificates.

65. A method according to claim 63, wherein the various financial media comprise credit cards, debit cards, checks, smart cards, and standard currency.

66. A method according to claim 59, the method further comprising evaluating the seller's goods, wherein the agent, during or following conferencing with the seller, determines an auctioning value of the goods.

67. A method according to claim 59, the method further comprising interactive screening of the goods.

68. A method according to claim 67, wherein the interactive screening is performed in real-time concurrent with receipt of goods into the network auction.

69. A method according to claim 67, wherein the interactive screening is further performed prior to a sale of the goods received into the network auction.

70. A method according to claim 59, the method further comprising conducting negotiations between the seller and the agent to structure an agreement for the agent to sell the seller's goods through a network auction to a buyer.

71. A method according to claim 62, wherein the freestanding device or kiosk is located in a public shopping area or a retail premise of a shipping center.

72. A method according to claim 59, wherein the seller's goods, following conferencing, evaluating, interactive screening, negotiating, shipping the goods to a holding location to facilitate interim storage of the goods and selling the goods, are shipped by the agent from the interim holding location to the buyer.

73. A method according to claims 72, wherein shipping is facilitated by a package carrier.

74. A method of facilitating exchange of goods through a network auction wherein the method comprises the steps of:
conferencing between a seller and an agent;
conducting negotiations between the seller and the agent to structure an agreement for the agent to sell the seller's goods through a network auction to a buyer;
shipping the goods to the buyer; and,
completing a financial transaction between the seller and the buyer through the agent.

75. A method according to claim 74, wherein the step of conferencing is facilitated by a remote auction terminal operatively connected to a network auction and the agent via a network freestanding device or kiosk.

76. A method according to claim 75, wherein the operative connection of the remote auction terminal is by land based phone systems, cable systems or wireless systems.

77. A method according to claim 75, wherein the remote auction terminal is a freestanding device or kiosk.

78. A method according to claim 77, wherein the freestanding device or kiosk includes capabilities selected from the group consisting of:
a. capability for live real-time or time delay conferencing;
b. capability for one-way, two-way or multiple-user video conferencing;
c. capability for input of electronic and written signatures;
d. capability for keyboard input of communications data;
e. capability for input and export of facsimile transmissions;
f. capability for input of digital and film photographs;
g. capability for printing labels, maps, and instructions;
h. capability for printing legal documents; and,
i. capability for receiving various financial media.

79. A method according to claim 78, wherein the legal documents comprise contracts, license agreements and signature verification certificates.

80. A method according to claim 78, wherein the various financial media comprise credit cards, debit cards, checks, smart cards, and standard currency.

81. A method according to claim 74, the method further comprising the step of evaluating seller's goods, wherein the agent determines an auctioning value of the goods.

82. A method according to claim 74, the method further comprising the step of interactive screening of the goods.

83. A method according to claim 82, wherein the interactive screening is performed in real-time concurrent with receipt of goods into the network auction.

84. A method according to claim 82, wherein the interactive screening is further performed prior to a sale of the goods received into the network auction.

85. A method according to claim 77, wherein the freestanding device or kiosk is located in a public shopping area or a retail premise of a shipping center.

86. A method according to claim 74, the method further comprising the step of shipping of seller's goods to a holding location to facilitate interim storage of the goods.

87. A method according to claim 86, wherein the seller's goods are shipped by the agent from the interim holding location to the buyer.

88. A method according to claim 85, wherein shipping is facilitated by a package carrier in conjunction with the shipping center.

89. A method of facilitating exchange of goods through a network auction wherein the method comprises the steps of:
conferencing between a seller and an agent, the conferencing facilitated by a remote auction terminal;
selling of seller's goods by the agent to a buyer;
shipping the goods to the buyer; and,
completing a financial transaction between the seller and the buyer through the agent.

90. A method according to claim 89, wherein the remote auction terminal is operatively connected to a network auction and the agent via a network.

91. A method according to claim 90, wherein the operative connection of the remote auction terminal is by land based phone systems, cable systems or wireless systems.

92. A method according to claim 90, wherein the remote auction terminal is a freestanding device or kiosk.

93. A method according to claim 92, wherein the freestanding device or kiosk includes capabilities selected from the group consisting of:
a. capability for live real-time or time delay conferencing;
b. capability for one-way, two-way or multiple-user video conferencing;
c. capability for input of electronic and written signatures;
d. capability for keyboard input of communications data;
e. capability for input and export of facsimile transmissions;
f. capability for input of digital and film photographs;
g. capability for printing labels, maps, and instructions;
h. capability for printing legal documents; and,
i. capability for receiving various financial media.

94. A method according to claim 93, wherein the legal documents comprise contracts, license agreements and signature verification certificates.

95. A method according to claim 93, wherein the various financial media comprise credit cards, debit cards, checks, smart cards, and standard currency.

96. A method according to claim 89, the method further comprising the step of evaluating seller's goods, wherein the agent determines an auctioning value of the goods.

97. A method according to claim 89, the method further comprising the step of conducting negotiations between the seller and the agent to structure an agreement for the agent to sell the seller's goods through a network auction to a buyer.

98. A method according to claim 92, wherein the freestanding device or kiosk is located in a public shopping area or a retail premise of a shipping center.

99. A method according to claim 89, the method further comprising the step of shipping of seller's goods to a holding location to facilitate interim storage of the goods.

100. A method according to claim 99, wherein the seller's goods are shipped by the agent from the interim holding location to the buyer.

101. A method according to claim 100, wherein shipping is facilitated by a package carrier.

102. A method of facilitating exchange of goods through a network auction wherein the method comprises the steps of:
conferencing between a seller and an agent, the conferencing facilitated by a remote auction terminal located in a public shopping area or a retail premise of a shipping center;
selling of seller's goods by the agent to a buyer;
shipping the goods to the buyer; and,
completing a financial transaction between the seller and the buyer through the agent.

103. A method according to claim 102, wherein the remote auction terminal is operatively connected to a network auction and the agent via a network.

104. A method according to claim 103, wherein the operative connection of the remote auction terminal is by land based phone systems, cable systems or wireless systems.

105. A method according to claim 103, wherein the remote auction terminal is a freestanding device or kiosk.

106. A method according to claim 105, wherein the freestanding device or kiosk includes capabilities selected from the group consisting of:
a. capability for live real-time or time delay conferencing;
b. capability for one-way, two-way or multiple-user video conferencing;
c. capability for input of electronic and written signatures;
d. capability for keyboard input of communications data;
e. capability for input and export of facsimile transmissions;
f. capability for input of digital and film photographs;
g. capability for printing labels, maps, and instructions;
h. capability for printing legal documents; and,
i. capability for receiving various financial media.

107. A method according to claim 106, wherein the legal documents comprise contracts, license agreements and signature verification certificates.

108. A method according to claim 106, wherein the various financial media comprise credit cards, debit cards, checks, smart cards, and standard currency.

109. A method according to claim 102, the method further comprising the step of evaluating seller's goods, wherein the agent determines an auctioning value of the goods.

110. A method according to claim 102, the method further comprising the step of conducting negotiations between the seller and the agent to structure an agreement for the agent to sell the seller's goods through a network auction to a buyer.

111. A method according to claim 102, the method further comprising the step of shipping of seller's goods to a holding location to facilitate interim storage of the goods.

112. A method according to claim 111, wherein the seller's goods are shipped by the agent from the interim holding location to the buyer.

113. A method according to claim 102, wherein shipping is facilitated by a package carrier in conjunction with the shipping center.

114. A method of facilitating exchange of goods through a network auction wherein the method comprises the steps of:
conferencing between a seller and an agent;
shipping of seller's goods to an interim holding location, wherein shipping is facilitated by a package carrier in conjunction with a shipping center;
selling of seller's goods by the agent to a buyer;
shipping the goods to the buyer; and,
completing a financial transaction between the seller and the buyer through the agent.

115. A method according to claim 114, wherein the step of conferencing is facilitated by a remote auction terminal operatively connected to a network auction and the agent via a network.

116. A method according to claim 115, wherein the operative connection of the remote auction terminal is by land based phone systems, cable systems or wireless systems.

117. A method according to claim 115, wherein the remote auction terminal is a freestanding device or kiosk.

118. A method according to claim 117, wherein the freestanding device or kiosk includes capabilities selected from the group consisting of:
a. capability for live real-time or time delay conferencing;
b. capability for one-way, two-way or multiple-user video conferencing;
c. capability for input of electronic and written signatures;
d. capability for keyboard input of communications data;
e. capability for input and export of facsimile transmissions;
f. capability for input of digital and film photographs;
g. capability for printing labels, maps, and instructions;
h. capability for printing legal documents; and,
i. capability for receiving various financial media.

119. A method according to claim 118, wherein the legal documents comprise contracts, license agreements and signature verification certificates.

120. A method according to claim 118, wherein the various financial media comprise credit cards, debit cards, checks, smart cards, and standard currency.

121. A method according to claim 114, the method further comprising the step of evaluating seller's goods, wherein the agent determines an auctioning value of the goods.

122. A method according to claim 114, the method further comprising the step of interactive screening of the goods.

123. A method according to claim 122, wherein the interactive screening is performed in real-time concurrent with receipt of goods into the network auction.

124. A method according to claim 122, wherein the interactive screening is further performed prior to a sale of the goods received into the network auction.

125. A method according to claim 114, the method further comprising the step of conducting negotiations between the seller and the agent to structure an agreement for the agent to sell the seller's goods through a network auction to a buyer.

126. A method according to claim 117, wherein the freestanding device or kiosk is located in a public shopping area or a retail premise of a shipping center.

127. A method according to claim 114, wherein the seller's goods are shipped by the agent from the interim holding location to the buyer.

128. A method of facilitating exchange of goods through a network auction wherein the method comprises the steps of:
conferencing between a seller and an agent, the conferencing facilitated by a remote auction terminal;
evaluating seller's goods, wherein the agent determines an auctioning value of the goods;
interactive screening of the goods, wherein the interactive screening is performed in real-time concurrent with receipt of goods into the network auction, and wherein the interactive screening is further performed prior to a sale of the goods received into the network auction;
conducting negotiations between the seller and the agent to structure an agreement for the agent to sell the seller's goods through a network auction to a buyer;
shipping of seller's goods to a holding location to facilitate interim storage of the goods;
selling of seller's goods by the agent through a network auction to a buyer;
shipping the goods from the interim holding location to the buyer; and,
completing a financial transaction between the seller and the buyer through the agent.

129. A method according to claim 128, wherein the remote auction terminal is operatively connected to a network auction and the agent via a network.

130. A method according to claim 129, wherein the operative connection of the remote auction terminal is by land based phone systems, cable systems or wireless systems.

131. A method according to claim 129, wherein the remote auction terminal is a freestanding device or kiosk.

132. A method according to claim 131, wherein the freestanding device or kiosk includes capabilities selected from the group consisting of:
a. capability for live real-time or time delay conferencing;
b. capability for one-way, two-way or multiple-user video conferencing;
c. capability for input of electronic and written signatures;
d. capability for keyboard input of communications data;
e. capability for input and export of facsimile transmissions;
f. capability for input of digital and film photographs;
g. capability for printing labels, maps, and instructions;
h. capability for printing legal documents; and,
i. capability for receiving various financial media.

133. A method according to claim 132, wherein the legal documents comprise contracts, license agreements and signature verification certificates.

134. A method according to claim 132, wherein the various financial media comprise credit cards, debit cards, checks, smart cards, and standard currency.

135. A method according to claim 131, wherein the freestanding device or kiosk is located in a public shopping area or a retail premise of a shipping center.

136. A method according to claim 135, wherein shipping is facilitated by a package carrier in conjunction with the shipping center.

137. A method of facilitating exchange of goods comprising the steps of:
conferencing between a buyer and an agent;
buying of goods by the agent through a network auction for the buyer;
facilitating shipping of the goods by the seller to the buyer; and,
completing a financial transaction between the buyer and the seller through the agent.

138. A method according to claim 137, wherein the step of conferencing is facilitated by a remote auction terminal.

139. A method according to claim 138, wherein the remote auction terminal is operatively connected to a network auction and the agent via a network.

140. A method according to claim 138, wherein the operative connection of the remote auction terminal is by land based phone systems, cable systems or wireless systems.

141. A method according to claim 138, wherein the remote auction terminal is a freestanding device or kiosk.

142. A method according to claim 141, wherein the freestanding device or kiosk includes capabilities selected from the group consisting of:
a. capability for live real-time or time delay conferencing;
b. capability for one-way, two-way or multiple-user video conferencing;
c. capability for input of electronic and written signatures;
d. capability for keyboard input of communications data;
e. capability for input and export of facsimile transmissions;
f. capability for input of digital and film photographs;
g. capability for printing labels, maps, and instructions;
h. capability for printing legal documents; and,
i. capability for receiving various financial media.

143. A method according to claim 142, wherein the legal documents comprise contracts, license agreements and signature verification certificates.

144. A method according to claim 142, wherein the various financial media comprise credit cards, debit cards, checks, smart cards, and standard currency.

145. A method according to claim 141, wherein the freestanding device or kiosk is located in a public shopping area or a retail premise of a shipping center.

146. A method according to claim 145, wherein shipping is facilitated by a package carrier in conjunction with the shipping center.

147. A method according to claim 137 the method further comprising the step of conducting negotiations between the buyer and the agent to structure an agreement to receive compensation for the agent to buy goods through a network auction for the buyer.

148. A method of facilitating exchange of goods through a network auction wherein the method comprises the steps of:
conferencing between a buyer and an agent, the conferencing facilitated by a remote auction terminal;
buying of goods by the agent through a network auction for the buyer;
facilitating shipping of the goods by the seller to the buyer; and,
completing a financial transaction between the buyer and the seller through the agent.

149. A method according to claim 148, wherein the remote auction terminal is operatively connected to a network auction and the agent via a network.

150. A method according to claim 149, wherein the operative connection of the remote auction terminal is by land based phone systems, cable systems or wireless systems.

151. A method according to claim 149, wherein the remote auction terminal is a freestanding device or kiosk.

152. A method according to claim 151, wherein the freestanding device or kiosk includes capabilities selected from the group consisting of:
a. capability for live real-time or time delay conferencing;
b. capability for one-way, two-way or multiple-user video conferencing;
c. capability for input of electronic and written signatures;
d. capability for keyboard input of communications data;
e. capability for input and export of facsimile transmissions;
f. capability for input of digital and film photographs;
g. capability for printing labels, maps, and instructions;
h. capability for printing legal documents; and,
i. capability for receiving various financial media.

153. A method according to claim 152, wherein the legal documents comprise contracts, license agreements and signature verification certificates.

154. A method according to claim 152, wherein the various financial media comprise credit cards, debit cards, checks, smart cards, and standard currency.

155. A method according to claim 151, wherein the freestanding device or kiosk is located in a public shopping area or a retail premise of a shipping center.

156. A method according to claim 155, wherein shipping is facilitated by a package carrier in conjunction with the shipping center.

157. A method according to claim 148 the method further comprising the step of conducting negotiations between the buyer and the agent to structure an agreement to receive compensation for the agent to buy goods through a network auction for the buyer.

158. A method of facilitating exchange of goods through a network auction wherein the method comprises the steps of:
conferencing between a buyer and an agent;
conducting negotiations between the buyer and the agent to structure an agreement to receive compensation for the agent to buy goods through a network auction for the buyer;
buying of goods by the agent through a network auction for the buyer;
facilitating shipping of the goods by the seller to the buyer; and,
completing a financial transaction between the buyer and the seller through the agent.

159. A method according to claim 158, wherein the step of conferencing is facilitated by a remote auction terminal.

160. A method according to claim 159, wherein the remote auction terminal is operatively connected to a network auction and the agent via a network.

161. A method according to claim 160, wherein the operative connection of the remote auction terminal is by land based phone systems, cable systems or wireless systems.

162. A method according to claim 159, wherein the remote auction terminal is a freestanding device or kiosk.

163. A method according to claim 162, wherein the freestanding device or kiosk includes capabilities selected from the group consisting of:
a. capability for live real-time or time delay conferencing;
b. capability for one-way, two-way or multiple-user video conferencing;
c. capability for input of electronic and written signatures;
d. capability for keyboard input of communications data;
e. capability for input and export of facsimile transmissions;
f. capability for input of digital and film photographs;
g. capability for printing labels, maps, and instructions;
h. capability for printing legal documents; and,
i. capability for receiving various financial media.

164. A method according to claim 163, wherein the legal documents comprise contracts, license agreements and signature verification certificates.

165. A method according to claim 163, wherein the various financial media comprise credit cards, debit cards, checks, smart cards, and standard currency.

166. A method according to claim 162, wherein the freestanding device or kiosk is located in a public shopping area or a retail premise of a shipping center.

167. A method according to claim 166, wherein shipping is facilitated by a package carrier in conjunction with the shipping center.

168. A method of facilitating exchange of goods through a network auction wherein the method comprises the steps of:
conferencing between a buyer and an agent, the conferencing facilitated by a remote auction terminal;
conducting negotiations between the buyer and the agent to structure an agreement to receive compensation for the agent to buy goods through a network auction for the buyer;
buying of goods by the agent through a network auction for the buyer;
facilitating shipping of the goods by the seller to the buyer; and,
completing a financial transaction between the buyer and the seller through the agent.

169. A method according to claim 168, wherein the remote auction terminal is operatively connected to a network auction and the agent via a network.

170. A method according to claim 169, wherein the operative connection of the remote auction terminal is by land based phone systems, cable systems or wireless systems.

171. A method according to claim 169, wherein the remote auction terminal is a freestanding device or kiosk.

172. A method according to claim 171, wherein the freestanding device or kiosk includes capabilities selected from the group consisting of:
a. capability for live real-time or time delay conferencing;
b. capability for one-way, two-way or multiple-user video conferencing;
c. capability for input of electronic and written signatures;
d. capability for keyboard input of communications data;
e. capability for input and export of facsimile transmissions;
f. capability for input of digital and film photographs;
g. capability for printing labels, maps, and instructions;
h. capability for printing legal documents; and,
i. capability for receiving various financial media.

173. A method according to claim 172, wherein the legal documents comprise contracts, license agreements and signature verification certificates.

174. A method according to claim 172, wherein the various financial media comprise credit cards, debit cards, checks, smart cards, and standard currency.

175. A method according to claim 171, wherein the freestanding device or kiosk is located in a public shopping area or a retail premise of a shipping center.

176. A method according to claim 175, wherein shipping is facilitated by a package carrier in conjunction with the shipping center.

177. A system for exchanging goods comprising:
a network;
a network auction; and,
a remote auction terminal operatively connected to the network auction via the network;
wherein the remote auction terminal facilitates interactive screening during receipt of goods into the network auction.
